(19) United States
(12) Patent Application Publication
(10) Pub. No.: US 2017/0328976 A1
(43) Pub. Date: Nov. 16, 2017

(54) OPERATION DEVICE, TRACKING SYSTEM, OPERATION METHOD, AND PROGRAM

(71) Applicant: FUJIFILM Corporation, Tokyo (JP)

(72) Inventor: Hiroyuki OSHIMA, Saitama-shi (JP)

(73) Assignee: FUJIFILM Corporation, Tokyo (JP)

(21) Appl. No.: 15/666,003

(22) Filed: Aug. 1, 2017

Related U.S. Application Data
(63) Continuation of application No. PCT/JP2015/080740, filed on Oct. 30, 2015.

(30) Foreign Application Priority Data
Feb. 2, 2015 (JP) 2015-018640

(51) Int. Cl. G01S 3/786; H04N 5/232

(52) U.S. Cl. CPC G01S 3/7865; H04N 5/23206; H04N 5/23296; H04N 5/23245

(57) ABSTRACT

An operation device according to an aspect of the invention includes: a receiving unit that receives images; a tracking target receiving unit that receives a specified tracking target which is tracked by the camera; a movement amount calculation unit that calculates the amount of movement of the tracking target in the images; a movement amount determination unit that determines whether the amount of movement calculated by the movement amount calculation unit is equal to or greater than a first movement amount threshold value; and a size instruction transmission unit that transmits an instruction to change the size of the image transmitted by the camera from a first size to a second size smaller than the first size to the camera in a case in which the movement amount determination unit determines that the amount of movement is equal to or greater than the first movement amount threshold value.

### CROSS-REFERENCE TO RELATED APPLICATIONS

The present application is a Continuation of PCT International Application No. PCT/JP2015/080740 filed on Oct. 30, 2015 claiming priority under 35 U.S.C §119(a) to Japanese Patent Application No. 2015-18640 filed on Feb. 2, 2015. Each of the above applications is hereby expressly incorporated by reference, in their entirety, into the present application.

### BACKGROUND OF THE INVENTION

### 1. Field of the Invention

The present invention relates to an operation device, a tracking system, an operation method, and a program, and more particularly, to an operation device, a tracking system, an operation method, and a program that track an object.

### 2. Description of the Related Art

A tracking imaging technique which continuously captures images while tracking a specific object has come into widespread use in the field of, for example, a surveillance camera or a general digital camera. Various methods have been proposed as a method for specifying the position of a specific object as a tracking target. For example, a method has been known which performs image processing for collating the features of a tracking target with a captured image to specify the position of the tracking target in the image.

In addition, a technique has been known which exchanges information between a camera with a function of tracking a tracking target and a remote operation device to track the tracking target.

Furthermore, a technique has been proposed which tracks a tracking target according to the movement of the tracking target.

For example, JP2014-216694A discloses a camera with an automatic tracking function and an operation device (remote operation device) and discloses a technique which increases the resolution of an image in a case in which a moving speed of a tracking target is less than a threshold value.

### SUMMARY OF THE INVENTION

However, the communication speed between the camera and the operation device is limited. Therefore, there is a trade-off relationship between the size (the number of pixels) of the image transmitted from the camera to the operation device and the frame rate received by the operation device. That is, in some cases, when the size of the image is large, it is difficult for the operation device to receive all of the frames and the frame rate received by the operation device tends to decrease.

In contrast, when the size of the image is small, the accuracy of distinguishing a small tracking target from other objects is reduced. As a result, in some cases, it is difficult for the camera that performs automatic tracking to continue to track the tracking target with high accuracy.

In a case in which a tracking target that moves at a high speed is tracked, when the frame rate is reduced, the amount of movement of the tracking target in the images increases. As a result, in some cases, it is difficult for the camera that performs automatic tracking to continue to track the tracking target with high accuracy.

The invention has been made in view of the above-mentioned problems and an object of the invention is to provide an operation device, a tracking system, an operation method, and a program that can continue to track a tracking target with high accuracy even when the tracking target is small or the amount of movement of the tracking target is large.

According to an aspect of the invention, there is provided an operation device that transmits control information for an automatic tracking function to a camera with the automatic tracking function. The operation device comprises: a receiving unit that receives images which are continuously transmitted from the camera; a tracking target receiving unit that receives a specified tracking target which is tracked by the camera; a movement amount calculation unit that calculates an amount of movement of the tracking target in the images continuously received by the receiving unit on the basis of the continuous images; a movement amount determination unit that determines whether the amount of movement calculated by the movement amount calculation unit is equal to or greater than a first movement amount threshold value; and a size instruction transmission unit that transmits an instruction to change a size of the image transmitted by the camera from a first size to a second size smaller than the first size to the camera in a case in which the movement amount determination unit determines that the amount of movement is equal to or greater than the first movement amount threshold value.

According to this aspect, in a case in which the amount of movement of the tracking target is equal to or greater than the first movement amount threshold value, an instruction to change the size of the image transmitted from the camera to a small size is transmitted. Therefore, a reduction in the frame rate received by the operation device is prevented and it is possible to continue to track a tracking target with high accuracy even when the amount of movement of the tracking target is large.

According to this aspect, in a case in which the amount of movement of the tracking target is less than the first movement amount threshold value, the instruction to change the size of the image transmitted from the camera to a small size is not transmitted. Therefore, the size of the image is not reduced and it is possible to continue to track a tracking target with high accuracy even when the tracking target is small.

Preferably, the operation device further comprises a tracking processing unit that performs image processing for the image to track the tracking target. Preferably, the tracking processing unit includes an evaluation value generation unit that generates an evaluation value indicating accuracy of the tracking and an evaluation value determination unit that determines whether the evaluation value generated by the evaluation value generation unit is equal to or greater than an evaluation value threshold value. Preferably, in a case in which the movement amount determination unit determines that the amount of movement is less than the first movement amount threshold value and the evaluation value determination unit determines that the evaluation value is equal to or greater than the evaluation value threshold value after the size instruction transmission unit transmits the instruction to change the size of the image to the second size, the size instruction transmission unit transmits an instruction to change the size of the image from the second size to the first size.

According to this aspect, in a case in which the amount of movement of an object is determined to be less than the first movement amount threshold value and the tracking evaluation value is determined to be equal to or greater than the evaluation value threshold value, an instruction to change the size of the image to the original large size is transmitted. Therefore, according to this aspect, the operation device can perform a tracking processing using an image with a large size. As a result, it is possible to perform tracking with high accuracy.

Preferably, the operation device further comprises a tracking processing unit that performs image processing to track the tracking target. Preferably, the tracking processing unit includes an evaluation value generation unit that generates an evaluation value indicating accuracy of the tracking and an evaluation value determination unit that determines whether the evaluation value generated by the evaluation value generation unit is equal to or greater than an evaluation value threshold value. Preferably, the movement amount determination unit determines whether the amount of movement is less than a second movement amount threshold value less than the first movement amount threshold value. Preferably, in a case in which the movement amount determination unit determines that the amount of movement is less than the second movement amount threshold value and the evaluation value determination unit determines that the evaluation value is equal to or greater than the evaluation value threshold value, the size instruction transmission unit generates an instruction to change the size of the image to a third size larger than the first size.

According to this aspect, in a case in which the amount of movement of an object is determined to be less than the second movement amount threshold value and the tracking evaluation value is determined to be equal to or greater than the evaluation value threshold value, the instruction to change the size of the image to the original large size is transmitted. Therefore, according to this aspect, the operation device can perform a tracking processing using an image with a large size. As a result, it is possible to perform tracking with high accuracy.

Preferably, the evaluation value generation unit generates the evaluation value on the basis of a sum of absolute values of differences between pixels of a template image and pixels of the image of a region corresponding to the template image in block matching.

According to this aspect, tracking is evaluated on the basis of the sum of the absolute values of the differences between the pixels of the template image and the pixels of the image of the region corresponding to the template image in block matching. Therefore, according to this aspect, tracking is evaluated with high accuracy. As a result, it is possible to perform tracking with high accuracy.

Preferably, the operation device further comprises: a frame rate detection unit that detects a frame rate of the image continuously received by the receiving unit; and a frame rate determination unit that determines whether the frame rate detected by the frame rate detection unit is less than a frame rate threshold value. Preferably, in a case in which the frame rate determination unit determines that the frame rate is less than the frame rate threshold value, the size instruction transmission unit transmits the instruction to change the size of the image to the second size.

According to this aspect, in a case in which the frame rate is less than the frame rate threshold value, the instruction to change the size of the image to the second size is transmitted. Therefore, an image with a small size is transmitted and it is possible to increase the frame rate which has been reduced. As a result, according to this aspect, it is possible to track a tracking target with high accuracy even when the amount of movement of the tracking target is large.

Preferably, the operation device further comprise a communication speed acquisition unit that acquires a communication speed with the camera on the basis of the frame rate detected by the frame rate detection unit.

According to this aspect, since the communication speed between the camera and the operation device is acquired on the basis of the frame rate, it is possible to acquire the communication speed with high accuracy.

Preferably, the operation device further comprises a communication information transmission unit that transmits information about a state of communication with the camera to the camera. In a case in which the frame rate determination unit determines that the frame rate is less than the frame rate threshold value, the communication information transmission unit transmits information about a communication error as the information about the communication state.

According to this aspect, in a case in which the frame rate is less than the frame rate threshold value, the information about the communication error is transmitted to the camera. Therefore, the camera can check the communication state of the operation device.

Preferably, the frame rate threshold value is set according to the size of the image transmitted by the camera.

According to this aspect, since the frame rate threshold value is set according to the size of the image, it is possible to determine the frame rate with high accuracy.

Preferably, the operation device further comprises: a display unit that displays the images continuously transmitted from the camera; and an input unit that designates an input position on a screen of the display unit. Preferably, the tracking target receiving unit receives an object at the input position designated by the input unit as the tracking target.

According to this aspect, when a position on a display screen of the display unit is designated by the input unit, the tracking target is received. Therefore, it is easy to specify the tracking target.

According to another aspect of the invention, there is provided a tracking system comprising a camera and an operation device that is used to operate the camera. The camera comprises: an imaging unit that acquires an image; an imaging direction switching mechanism that switches an imaging direction of the imaging unit; an image transmission unit that transmits the image; an instruction receiving unit that receives an instruction from the operation device; and a size change unit that changes a size of the image transmitted from the image transmission unit to the operation device on the basis of an instruction from the operation device which transmits an instruction to change the size of image according to a reception state of the image transmitted by the image transmission unit. The operation device comprises: a receiving unit that receives the images which are continuously transmitted from the camera; a tracking target receiving unit that receives a specified tracking target which is tracked by the camera; a movement amount calculation unit that calculates an amount of movement of the tracking target in the images continuously received by the receiving unit on the basis of the continuous images; a movement amount determination unit that determines whether the amount of movement calculated by the movement amount calculation unit is equal to or greater than a first movement amount threshold value; and a size instruction transmission unit that transmits an instruction to change the resolution of the image transmitted by the camera from a first size to a second size smaller than the first size to the camera in a case in which the movement amount determination unit determines that the amount of movement is equal to or greater than the first movement amount threshold value.

According to still another aspect of the invention, there is provided an operation method that transmits control information for an automatic tracking function to a camera with the automatic tracking function. The operation method comprises: a receiving step of receiving images which are continuously transmitted from the camera; a tracking target receiving step of receiving a specified tracking target which is tracked by the camera; a movement amount calculation step of calculating an amount of movement of the tracking target in the images continuously received in the receiving step on the basis of the continuous images; a movement amount determination step of determining whether the amount of movement calculated in the movement amount calculation step is equal to or greater than a first movement amount threshold value; and a size instruction transmission step of transmitting an instruction to change a size of the image transmitted by the camera from a first size to a second size smaller than the first size to the camera in a case in which it is determined in the movement amount determination step that the amount of movement is equal to or greater than the first movement amount threshold value.

Preferably, the operation method further comprises a tracking processing step of performing image processing for the image to track the tracking target. Preferably, the tracking processing step includes: an evaluation value generation step of generating an evaluation value indicating accuracy of the tracking; and an evaluation value determination step of determining whether the evaluation value generated in the evaluation value generation step is equal to or greater than an evaluation value threshold value. Preferably, in a case in which it is determined in the movement amount determination step that the amount of movement is less than the first movement amount threshold value and it is determined in the evaluation value determination step that the evaluation value is equal to or greater than the evaluation value threshold value after the instruction to change the size of the image to the second size is transmitted, an instruction to change the size of the image from the second size to the first size is transmitted in the size instruction transmission step.

Preferably, the operation method further comprises a tracking processing step of performing image processing to track the tracking target. Preferably, the tracking processing step includes: an evaluation value generation step of generating an evaluation value indicating accuracy of the tracking; and an evaluation value determination step of determining whether the evaluation value generated in the evaluation value generation step is equal to or greater than an evaluation value threshold value. Preferably, in the movement amount determination step, it is determined whether the amount of movement is less than a second movement amount threshold value less than the first movement amount threshold value. Preferably, in a case in which it is determined in the movement amount determination step that the amount of movement is less than the second movement amount threshold value and it is determined in the evaluation value determination step that the evaluation value is equal to or greater than the evaluation value threshold value, an instruction to change the size of the image to a third size larger than the first size is generated in the size instruction transmission step.

Preferably, in the evaluation value generation step, the evaluation value is generated on the basis of a sum of absolute values of differences between pixels of a template image and pixels of the image of a region corresponding to the template image in block matching.

Preferably, the operation method further comprises: a frame rate detection step of detecting a frame rate of the image continuously received in the receiving step; and a frame rate determination step of determining whether the frame rate detected in the frame rate detection step is less than a frame rate threshold value. Preferably, in a case in which it is determined in the frame rate determination step that the frame rate is less than the frame rate threshold value, the instruction to change the size of the image to the second size is transmitted in the size instruction transmission step.

Preferably, the operation method further comprises a communication speed acquisition step of acquiring a communication speed with the camera on the basis of the frame rate detected in the frame rate detection step.

Preferably, the operation method further comprises a communication information transmission step of transmitting information about a state of communication with the camera to the camera. Preferably, in a case in which it is determined in the frame rate determination step that the frame rate is less than the frame rate threshold value, information about a communication error is transmitted as the information about the communication state in the communication information transmission step.

Preferably, the frame rate threshold value is set according to the size of the image transmitted by the camera.

Preferably, the operation method further comprises a display step of displaying the images continuously transmitted from the camera; and an input step of designating an input position on a screen in the display step. Preferably, in the tracking target receiving step, an object at the input position designated in the input step is received as the tracking target.

According to yet another aspect of the invention, there is provided a program that causes a computer to perform an operation method which transmits control information for an automatic tracking function to a camera with the automatic tracking function. The operation method includes: a receiving step of receiving images which are continuously transmitted from the camera; a tracking target receiving step of receiving a specified tracking target which is tracked by the camera; a movement amount calculation step of calculating an amount of movement of the tracking target in the images continuously received in the receiving step on the basis of the continuous images; a movement amount determination step of determining whether the amount of movement calculated in the movement amount calculation step is equal to or greater than a first movement amount threshold value; and a size instruction transmission step of transmitting an instruction to change a size of the image transmitted by the camera from a first size to a second size smaller than the first size to the camera in a case in which it is determined in the movement amount determination step that the amount of movement is equal to or greater than the first movement amount threshold value.

According to the invention, in a case in which the amount of movement of the tracking target is equal to or greater than the first movement amount threshold value, an instruction to change the size of the image transmitted from the camera to a small size is transmitted. Therefore, a reduction in the frame rate received by the operation device is prevented and it is possible to continue to track a tracking target with high accuracy even when the amount of movement of the tracking target is large. In addition, according to the invention, in a case in which the amount of movement of the tracking target is less than the first movement amount threshold value, the instruction to change the size of the image transmitted from the camera to a small size is not transmitted. Therefore, the image size is not reduced and it is possible to continue to track a tracking target with high accuracy even when the tracking target is small.

### BRIEF DESCRIPTION OF THE DRAWINGS

FIG. 1 is an external perspective view illustrating an example of a tracking system.

FIG. 2 is a block diagram illustrating an example of the functional structure of a camera.

FIG. 3 is a block diagram illustrating an example of the functional structure of an operation device.

FIG. 4 is a flowchart illustrating the operation of an operation device according to a first embodiment.

FIG. 5 is a flowchart illustrating the operation of an operation device according to a second embodiment.

FIG. 6 is a flowchart illustrating the operation of an operation device according to a third embodiment.

FIG. 7 is a block diagram illustrating an example of the functional structure of an operation device according to a fourth embodiment.

FIG. 8 is a flowchart illustrating the operation of the operation device according to the fourth embodiment.

### DESCRIPTION OF THE PREFERRED EMBODIMENTS

Hereinafter, preferred embodiments of an imaging device and an imaging method according to the invention will be described with reference to the accompanying drawings.

Hereinafter, preferred embodiments of the invention will be described with reference to the accompanying drawings.

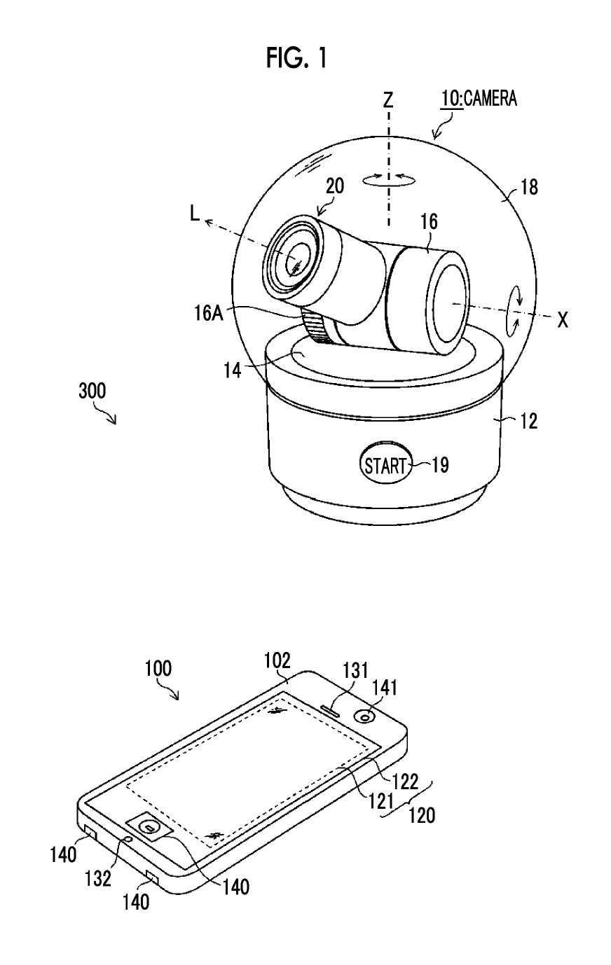

FIG. 1 is an external perspective view illustrating an example of a tracking system 300 according to an aspect of the invention. The tracking system 300 comprises an operation device 100 (smart phone) and a camera 10 (a pan/tilt camera with an automatic tracking function).

The operation device 100 is used to operate the camera 10. In the example illustrated in FIG. 1, the operation device 100 wirelessly operates the camera 10. However, the invention is not limited thereto. The operation device 100 may be connected to the camera 10 in a wired manner.

The camera 10 mainly includes a device body 12, a base 14, a holding portion 16 which is fixed to the base 14 and holds an imaging unit 20 so as to be rotatable, and a dome cover 18 which covers the imaging unit 20.

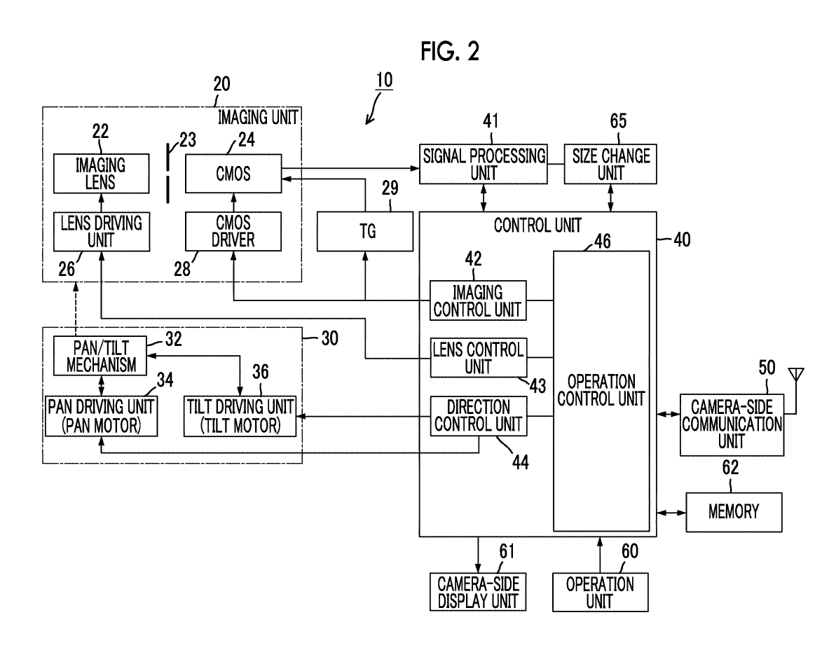

The base 14 is provided so as to be rotatable about the axis of the vertical direction Z of the device body 12 and is rotated about the axis of the vertical direction Z by a pan driving unit 34 (FIG. 2).

The holding portion 16 includes a gear 16A that is provided on the same axis as the horizontal direction X. A driving force is transmitted from a tilt driving unit 36 (FIG. 2) through the gear 16A to rotate (tilt) the imaging unit 20 in the vertical direction.

The dome cover 18 is a dustproof and drip-proof cover and preferably has a domic shape which has a constant thickness and has, as a center of curvature, an intersection point between the axis of the horizontal direction X and the axis of the vertical direction Z such that the optical performance of the imaging unit 20 does not change, regardless of an optical axis direction L of the imaging unit 20.

It is preferable to provide a tripod attachment portion (for example, tripod screws) (not illustrated) on the rear surface of the device body 12.

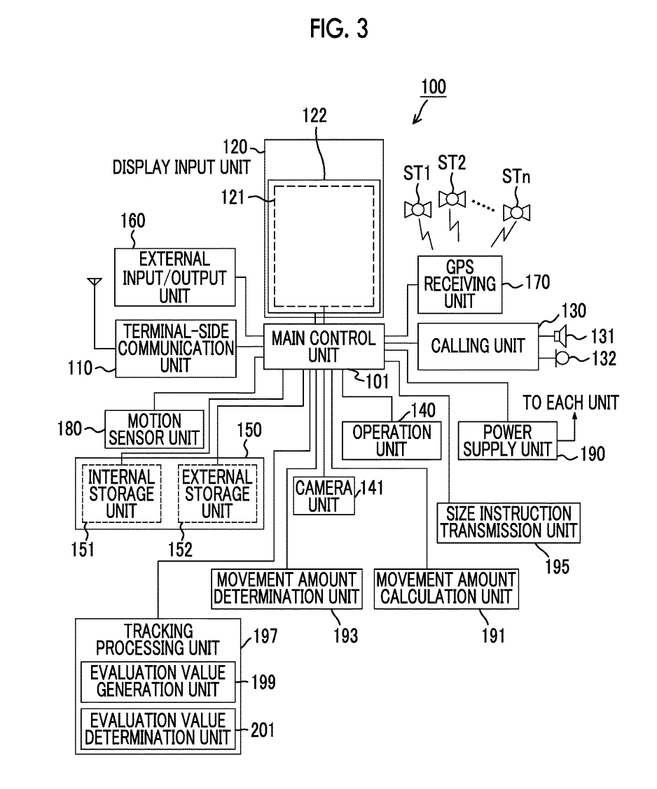

The camera 10 is provided with an imaging start button 19 that instructs to start imaging and a power switch (not illustrated). The camera 10 includes a camera-side communication unit 50 (FIG. 2) and mainly receives various types of operation instructions input from an external operation device (a smart phone in this example) 100 using wireless communication with the operation device 100. The camera 10 acquires information related to the position of a tracking target obtained by analyzing captured image data from the operation device 100, using wireless communication. The operation device 100 will be described with reference to FIG. 3. In addition, the camera 10 may comprise a warning display unit (not illustrated) that displays a warning against the error of a communication state.

FIG. 2 is a block diagram illustrating an example of the functional structure of the camera 10 (pan/tilt camera).

The camera 10 can capture both still images and moving images and mainly comprises the imaging unit 20, an imaging direction adjustment unit 30, a control unit 40, a signal processing unit 41, a camera-side display unit 61, an operation unit 60, a memory 62, a camera-side communication unit 50, and a size change unit 65.

The imaging unit 20 includes, for example, an imaging lens 22 and an imaging element (CMOS) 24 and continuously acquire captured image data. The imaging lens 22 is a prime lens or a zoom lens and forms an object image on an imaging surface of the imaging element 24. A focus lens, a variable magnification lens (in the case of a zoom lens), and a stop 23 included in the imaging lens 22 are driven by a lens driving unit 26.

The imaging element 24 is a color imaging element in which color filters of three primary colors, that is, red (R), green (G), and blue (B) are arranged in a predetermined pattern (a Bayer array, a G stripe R/B full-checkered pattern, an X-Trans (registered trademark) array, or a honeycomb array) for each pixel and is a complementary metal oxide semiconductor (CMOS) image sensor. However, the imaging element 24 is not limited to the CMOS image sensor and may be a charge coupled device (CCD) image sensor.

The imaging element 24 is driven by a CMOS driver 28 including, for example, a vertical driver and a horizontal driver and a timing generator (TG) 29. A pixel signal corresponding to the amount of incident object light (a digital signal corresponding to signal charge accumulated in each pixel) is read from the imaging element 24.

The imaging direction adjustment unit 30 comprises, for example, a pan/tilt mechanism 32, the pan driving unit 34, and the tilt driving unit 36 and adjusts the imaging direction of the imaging unit 20. As illustrated in FIG. 1, the pan/tilt mechanism (imaging direction switching mechanism) 32 includes a pan mechanism that rotates the imaging unit 20 in the horizontal direction (pan direction) with respect to the device body 12 and a tilt mechanism that rotates the imaging unit 20 in the vertical direction (tilt direction) with respect to the device body 12. The pan/tilt mechanism 32 includes a home position sensor that detects the reference position of a rotation angle (pan angle) in the pan direction and a home position sensor that detects the reference position of an inclination angle (tilt angle) in the tilt direction. The pan/tilt mechanism 32 switches the imaging direction of the imaging unit 20.

The pan driving unit 34 and the tilt driving unit 36 each include a stepping motor and a motor driver and output a driving force to the pan/tilt mechanism 32 to drive the pan/tilt mechanism 32.

The signal processing unit 41 performs signal processing, such as an offset process, a gain control process including white balance correction and sensitivity correction, a gamma correction process, demosaic processing (demosaicing process), and an RGB/YC conversion process, for a digital image signal (captured image data) which is input from the imaging unit 20. Here, the demosaicing process is a process which calculates all color information of each pixel from a mosaic image corresponding to the color filter array of a single-plate-type color imaging element and is also referred to as a synchronization process. For example, in the case of an imaging element including color filters of three colors, that is, R, G, and B, the demosaicing process calculates the color information of all of R, G, and B of each pixel from an RGB mosaic image. In addition, the RGB/YC conversion process is a process which generates brightness data Y and color difference data items Cb and Cr from the demosaiced RGB image data. The signal processing unit 41 transmits the captured image data subjected to the above-mentioned processes.

The size change unit 65 changes the size of the image to be transmitted to the operation device 100. That is, the size change unit 65 changes the size of the image to be displayed as a live view image on the operation device 100 in order to transmit the image to the operation device 100. For example, in a case in which the image acquired from the signal processing unit 41 is a full high definition (HD) (1920×1080) image for recording, the size change unit 65 reduces the size of the full HD image to a video graphics array (VGA) size (640×480). In addition, the size change unit 65 may change the size of the image to be transmitted from an image transmission unit to the operation device 100 on the basis of an instruction from the operation device 100 that transmits an image size change instruction according to the reception state of the image transmitted by the image transmission unit. For example, in a case in which a VGA image has been transmitted to the operation device 100, when an instruction to reduce the size of the image is received from the operation device 100 through the camera-side communication unit 50, the size change unit 65 changes the size of the image to a quarter video graphics array (QVGA) size (320×240). The size of the image is not limited to the above-mentioned HD, VGA, and QVGA sizes and various image sizes are used. The size change unit 65 may increase the size of the image as well as reducing the size of the image.

The control unit 40 comprises, as main components, an imaging control unit 42, a lens control unit 43, a direction control unit 44, and an operation control unit 46.

The imaging control unit 42 issues, for example, an instruction to discharge the charge accumulated in a capacitor of each pixel of the imaging element 24 or an instruction to read a signal corresponding to the charge accumulated in the capacitor through the CMOS driver 28 and the TG 29 and performs imaging control.

The lens control unit 43 controls the focus lens, the variable magnification lens, and the stop 23 included in the imaging lens 22 through the lens driving unit 26 and performs, for example, auto focus (AF) control for moving the focus lens to an in-focus position. The AF control is performed by integrating the absolute values of high-frequency components of a digital signal corresponding to an AF area, detecting an in-focus position where the integrated value (AF evaluation value) is the maximum, and moving the focus lens to the detected in-focus position.

The direction control unit 44 controls the imaging direction adjustment unit 30. Specifically, in a case in which an automatic tracking mode is set, the direction control unit 44 controls the imaging direction adjustment unit 30 such that an object (tracking target) is located at the center of the angle of view. In a case in which the automatic tracking mode is not set, the direction control unit 44 controls the imaging direction adjustment unit 30 in response to an instruction transmitted from the operation unit 60 or the operation device 100.

The operation control unit 46 controls the operation of the imaging control unit 42, the lens control unit 43, and the direction control unit 44. For example, the operation control unit 46 controls the direction control unit 44 such that the pan/tilt mechanism 32 is operated or stopped. In addition, the operation control unit 46 transmits control information for a tracking function to the direction control unit 44 and controls the pan/tilt mechanism 32 through the direction control unit 44 such that a tracking target is tracked. The operation control unit 46 stops the recording of a captured moving image to the memory 62 or cancels the stopping. The operation control unit 46 stops the capture of a moving image by the imaging unit 20 and changes the mode to a power saving mode or cancels the power saving mode.

The camera-side communication unit 50 performs wireless communication with the external operation device 100 illustrated in FIG. 1 and functions as an image transmission unit that transmits an image to the operation device 100 and an instruction receiving unit that receives instructions from the operation device 100. The camera-side communication unit 50 can transmit, for example, a recording image to the operation device 100. In addition, the camera-side communication unit 50 can transmit the moving image (captured image data) which has been captured by the imaging unit 20 and then processed by the signal processing unit 41 to the operation device 100. In this way, a recording image, such as a moving image, can be recorded in the operation device 100 or an external recording medium or a live view image can be displayed on a display unit (display input unit 120) of the operation device 100. For example, the camera-side communication unit 50 can receive the image size change instruction transmitted from the operation device 100.

The operation unit 60 includes, for example, the imaging start button 19 (FIG. 1) and a power button which are provided in the device body 12 and can be used to input the same operation instruction as the operation instruction from the operation device 100.

The camera-side display unit 61 functions as an image display unit which displays, for example, a live view image and a playback image and also functions as a user interface unit for displaying a menu screen and for setting and inputting various parameters, in cooperation with the operation unit 60.

The memory 62 includes, for example, a synchronous dynamic random access memory (SDRAM) serving as a storage area that temporarily stores still images or moving images or a work area that performs various types of arithmetic processing or a read only memory (ROM) that stores an imaging program and various kinds of data required for control. The operation control unit 46 controls the recording of the moving image captured by the imaging unit 20 in the memory 62.

FIG. 3 is a block diagram illustrating an example of the functional structure of the operation device 100.

As illustrated in FIG. 3, the operation device 100 comprises, as main components, a terminal-side communication unit (receiving unit) 110, a display input unit 120, a calling unit 130, an operation unit 140, a camera unit 141, a storage unit 150, an external input/output unit 160, a global positioning system (GPS) receiving unit 170, a motion sensor unit 180, a power supply unit 190, a movement amount determination unit 193, a movement amount calculation unit 191, a tracking processing unit 197, and a main control unit 101. In addition, the operation device 100 has, as a main function, a wireless communication function which performs mobile wireless communication through a base station apparatus BS and a mobile communication network NW.

The terminal-side communication unit 110 performs wireless communication with the base station apparatus BS which is accommodated in the mobile communication network NW in response to an instruction from the main control unit 101. The wireless communication is used to transmit and receive various types of file data, such as voice data and image data, and electronic mail data or to receive, for example, web data or streaming data. In this example, the terminal-side communication unit 110 of the operation device 100 transmits various operation instruction inputs to the camera 10 or functions as a receiving unit that receives, for example, the image (live view image) and the recording image which are continuously transmitted from the camera 10.

The display input unit 120 displays, for example, images (still images and moving images) or text information to visually transmit information to the user and detects the user's operation for the displayed information under the control of the main control unit 101. The display input unit 120 comprises a display panel 121 and an operation panel (touch panel) 122. It is preferable that the display panel 121 is a 3D display panel in a case in which a 3D image is viewed. The display input unit 120 also functions as a tracking target receiving unit that receives a specified tracking target that is tracked by the camera 10.

The display panel 121 uses, for example, a liquid crystal display (LCD) or an organic electro-luminescence display (OELD) as a display device and functions as a display unit that displays the images continuously transmitted from the camera 10.

The operation panel (input unit) 122 is a device that is provided such that an image displayed on a display surface of the display panel 121 is visually recognized and detects one or a plurality of coordinate points operated by a finger of the user or a stylus. When the device is operated by a finger of the user or a stylus, a detection signal which is generated by the operation is output to the main control unit 101. Then, the main control unit 101 detects an operation position (coordinates) on the display panel 121 on the basis of the received detection signal and designates an input position on the screen of the display unit.

As illustrated in FIG. 1, the display panel 121 and the operation panel 122 of the operation device 100 are integrated to form the display input unit 120 and the operation panel 122 is provided so as to completely cover the display panel 121. In a case in which this structure is used, the operation panel 122 may have a function of detecting the user's operation even in a region other than the display panel 121. In other words, the operation panel 122 may comprise a detection region (hereinafter, referred to as a display region) for an overlap portion which overlaps the display panel 121 and a detection region (hereinafter, referred to as a non-display region) for an outer edge portion which does not overlap the display panel 121.

The size of the display region may be exactly equal to the size of the display panel 121. However, the sizes are not necessarily equal to each other. The operation panel 122 may comprise two sensitive regions, that is, an outer edge portion and an inner portion other than the outer edge portion. The width of the outer edge portion is appropriately designed according to, for example, the size of a housing 102. Examples of a position detecting method which is used in the operation panel 122 include a matrix switching method, a resistive film method, a surface elastic wave method, an infrared method, an electromagnetic induction method, and a capacitive sensing method. Any of the methods may be used.

The calling unit 130 comprises a speaker 131 and a microphone 132. The calling unit 130 converts the voice of the user which is input through the microphone 132 into voice data which can be processed by the main control unit 101 and outputs the converted voice data to the main control unit 101. In addition, the calling unit 130 decodes voice data received by the terminal-side communication unit 110 or the external input/output unit 160 and outputs the decoded voice data from the speaker 131. As illustrated in FIG. 1, for example, the speaker 131 and the microphone 132 can be mounted on the same surface as the display input unit 120.

The operation unit 140 is a hardware key which uses, for example, a key switch and receives instructions from the user. For example, the operation unit 140 is a push button switch which is mounted on a lower surface of a lower portion of the display input unit 120 of the housing 102 of the operation device 100, is turned on when it is pressed by, for example, a finger, and is turned off by the restoring force of a spring when the finger is taken off.

The storage unit 150 stores a control program or control data of the main control unit 101, address data which is associated with, for example, the names or phone numbers of communication partners, and transmitted and received electronic mail data, web data which is downloaded by web browsing, or downloaded content data. In addition, the storage unit 150 temporarily stores, for example, streaming data. The storage unit 150 includes an internal storage unit 151 which is provided in a smart phone and an external storage unit 152 which has a slot for a detachable external memory. The internal storage unit 151 and the external storage unit 152 forming the storage unit 150 may be implemented by a storage medium, such as a flash memory, a hard disk, a multimedia-card-micro-type memory, a card-type memory (for example, a MicroSD (registered trademark) memory), a random access memory (RAM), or a read only memory (ROM).

The external input/output unit 160 functions as an interface with all of the external apparatuses connected to the operation device 100 and is directly or indirectly connected to other external apparatuses by communication (for example, universal serial bus (USB) communication) or a network (for example, the Internet, a wireless local area network (LAN), a Bluetooth (registered trademark) network, a radio frequency identification (RFID) network, an infrared data association (IrDA (registered trademark)) network, an ultra wideband (UWB) (registered trademark) network, or a ZigBee (registered trademark) network).

Examples of the external apparatus connected to the operation device 100 include a wired/wireless headset, a wired/wireless external charger, a wired/wireless data port, a memory card which is connected through a card socket, a subscriber identity module (SIM)/user identity module (UIM) card, an external audio/video apparatus which is connected through an audio/video input/output (I/O) terminal, a wirelessly connected external audio/video apparatus, a smart phone which is connected wirelessly or in a wired manner, a personal computer which is connected wirelessly or in a wired manner, a personal digital assistant (PDA) which is connected wirelessly or in a wired manner, a personal computer which is connected wirelessly or in a wired manner, and an earphone. The external input/output unit 160 can transmit data which is received from the external apparatus to each component of the operation device 100 or can transmit data in the operation device 100 to the external apparatus.

The GPS receiving unit 170 receives GPS signals transmitted from GPS satellites STI to STn and performs a position measurement process on the basis of a plurality of received GPS signals to detect a position including the latitude, longitude, and height of the operation device 100, in response to an instruction from the main control unit 101. When the GPS receiving unit 170 can acquire positional information from the terminal-side communication unit 110 or the external input/output unit 160 (for example, a wireless LAN), it can detect the position using the positional information.

The motion sensor unit 180 comprises, for example, a triaxial acceleration sensor and detects the physical movement of the operation device 100 in response to an instruction from the main control unit 101. When the physical movement of the operation device 100 is detected, the moving direction or acceleration of the operation device 100 is detected. The detection result is output to the main control unit 101.

The power supply unit 190 supplies power which is stored in a battery (not illustrated) to each unit of the operation device 100 in response to an instruction from the main control unit 101.

The main control unit 101 comprises a microprocessor, operates on the basis of the control program or control data stored in the storage unit 150, and controls the overall operation of each unit of the operation device 100. The main control unit 101 has an application processing function and a mobile communication control function of controlling each unit of a communication system in order to perform voice communication or data communication through the terminal-side communication unit 110.

The application processing function is implemented by the operation of the main control unit 101 based on the application software which is stored in the storage unit 150. Examples of the application processing function include an infrared communication function which controls the external input/output unit 160 such that data communication with an opposing apparatus is performed, an electronic mail function which transmits and receives electronic mail, and a web browsing function which browses web pages.

The main control unit 101 has an image processing function that displays a video on the display input unit 120 on the basis of image data (still image data or moving image data) such as received data or downloaded streaming data. The image processing function means the function of the main control unit 101 decoding the image data, performing image processing for the decoding result, and displaying the image on the display input unit 120.

The main control unit 101 performs display control for the display panel 121 and operation detection control for detecting the user's operation through the operation unit 140 and the operation panel 122.

The main control unit 101 performs display to display a software key, such as an icon for starting application software or a scroll bar, or a window for creating electronic mail. The scroll bar means a software key for receiving an instruction to move a displayed portion of an image that is too large to fit into the display region of the display panel 121.

The main control unit 101 performs operation detection control to detect the user's operation through the operation unit 140 and the operation panel 122.

In addition, the main control unit 101 performs the operation detection control to detect the user's operation through the operation unit 140, to receive an operation for the icon or the input of a character string to an input field of the window through the operation panel 122, or to receive a request to scroll the displayed image through the scroll bar.

The main control unit 101 has a touch panel control function that performs the operation detection control to determine whether the position of an operation for the operation panel 122 is an overlap portion (display region) which overlaps the display panel 121 or an outer edge portion (non-display region) which does not overlap the display panel 121 other than the overlap portion and controls a sensitive region of the operation panel 122 or the display position of the software key.

The main control unit 101 can detect a gesture operation for the operation panel 122 and can perform a predetermined function according to the detected gesture operation. The gesture operation does not mean a simple touch operation according to the related art, but means an operation which draws a trace using a finger, an operation which designates a plurality of positions at the same time, or a combination thereof which draws a trace for at least one of the plurality of positions.

The camera unit 141 is a digital camera which performs electronic imaging (imaging) using an imaging element such as a complementary metal oxide semiconductor (CMOS) sensor or a charge-coupled device (CCD).

The camera unit 141 can convert captured image data into image data which is compressed in, for example, a Joint Photographic Coding Experts Group (JPEG) format and record the converted image data in the storage unit 150 or output the converted image data through the external input/output unit 160 or the terminal-side communication unit 110, under the control of the main control unit 101.

In the operation device 100 illustrated in FIG. 1, the camera unit 141 is mounted on the same surface as the display input unit 120. However, the mounting position of the camera unit 141 is not limited thereto. For example, the camera unit 141 may be mounted on the rear surface of the display input unit 120 or a plurality of camera units 141 may be mounted. In a case in which a plurality of camera units 141 are mounted, the camera units 141 which are used to capture images may be switched such that a single camera unit captures images or the plurality of camera units 141 may be simultaneously used to capture images.

The camera unit 141 can be used for various functions of the operation device 100. For example, the image captured by the camera unit 141 can be displayed on the display panel 121 or the image captured by the camera unit 141 can be used as one of the operation inputs of the operation panel 122. When detecting the position, the GPS receiving unit 170 may detect the position with reference to the image from the camera unit 141. In addition, the optical axis direction of the camera unit 141 in the operation device 100 may be determined or the current usage environment may be determined, with reference to the image from the camera unit 141, using the triaxial acceleration sensor or without using, the triaxial acceleration sensor. Of course, the image from the camera unit 141 may be used in the application software.

In this example, application software for operating the camera 10 is downloaded through, for example, a network and is stored in the storage unit 150. The main control unit 101 is operated by the application processing function of the operation device 100 according to the downloaded application software to make the general-purpose operation device 100 function as a user interface unit for operating the camera 10.

The movement amount calculation unit 191 calculates the amount of movement of the tracking target in the images continuously received by the terminal-side communication unit 110 on the basis of the continuous images. The movement amount calculation unit 191 can calculate the amount of movement of the tracking target using various known methods. For example, the movement amount calculation unit 191 acquires the coordinates of the tracking target in an image at a first time and the coordinates of the tracking target in an image at a second time and calculates the distance between two coordinate points to calculate the amount of movement.

The movement amount determination unit 193 determines whether the amount of movement calculated by the movement amount calculation unit 191 is equal to or greater than a first movement amount threshold value. That is, the movement amount determination unit 193 compares the amount of movement calculated by the movement amount calculation unit 191 with the first movement amount threshold value to perform the determination and determines whether the amount of movement of the tracking target is large (the moving speed of the tracking target is high) or small (the moving speed of the tracking target is low). The first movement amount threshold value is an arbitrary threshold value and is not particularly limited. For example, the first movement amount threshold value is determined considering the performance of a tracking process (tracking operation) of the tracking processing unit 197 and a frame rate.

In a case in which the movement amount determination unit 193 determines that the amount of movement is equal to or greater than the first movement amount threshold value, a size instruction transmission unit 195 transmits an instruction to change the size of the image transmitted by the camera 10 from a first size to a second size larger than the first size to the camera 10. That is, in a case in which the movement amount determination unit 193 determines that the amount of movement is equal to or greater than the first movement amount threshold value, since the moving speed of the tracking target is high, the size instruction transmission unit 195 transmits an instruction to reduce the size of the image transmitted by the camera 10 to maintain the frame rate received by the operation device 100 (to prevent a reduction in the frame rate). Therefore, even in a case in which the camera tracks the tracking target that moves at a high speed, it is possible to continue to track the tracking target with high accuracy. In addition, in a case in which the amount of movement of the tracking target is less than the first movement amount threshold value, the size instruction transmission unit 195 does not transmit the instruction to change the size of the image transmitted from the camera 10 to a small size. Therefore, the size of the image is not reduced and it is possible to continue to track a tracking target with high accuracy even when the tracking target is small.

The tracking processing unit 197 performs image processing for the images which are continuously transmitted from the camera 10 to track a specified tracking target. For example, the tracking processing unit 197 detects the tracking target, using a block matching process, a pattern matching process, or a face detection process, and acquires the coordinates of the tracking target. Since the block matching process, the pattern matching process, or the face detection process is known, the description thereof will not be repeated. The tracking processing unit 197 transmits the acquired coordinates of the tracking target as information (control information for a tracking function) for controlling the pan/tilt mechanism 32 to the camera 10 through the terminal-side communication unit 110. In addition, the tracking processing unit 197 can perform automatic or manual tracking. In the case of the automatic tracking, the tracking processing unit 197 continuously detects the tracking target which has been specified once. In the case of the manual tracking, the tracking processing unit 197 sequentially detects the specified tracking target.

The tracking processing unit 197 includes an evaluation value generation unit 199 and an evaluation value determination unit 201. The evaluation value generation unit 199 generates an evaluation value indicating the accuracy of tracking. For example, the evaluation value generation unit 199 generates the evaluation value on the basis of the sum of the absolute values of the differences between the pixels of a template image and the pixels of an image of a region corresponding to the template image in block matching. Here, the sum of the absolute values of the differences between the pixels of the template image and the pixels of the image of the region corresponding to the template image in block matching is generally called as the sum of squared differences (SSD) or the sum of absolute differences (SAD). For example, a known method is used to calculate the SSD and the SAD.

The evaluation value determination unit 201 determines whether the evaluation value generated by the evaluation value generation unit 199 is equal to or greater than an evaluation value threshold value. That is, the evaluation value determination unit 201 compares the evaluation value calculated by the evaluation value generation unit 199 with the evaluation value threshold value to perform the determination and determines whether tracking is accurately performed. For example, in a case in which the evaluation value is equal to or greater than the evaluation value threshold value, the evaluation value determination unit 201 determines that tracking is not accurately performed. In a case in which the evaluation value is less than the evaluation value threshold value, the evaluation value determination unit 201 determines that tracking is accurately performed. Here, the evaluation value threshold value is determined considering the desired performance of tracking.

### First Embodiment

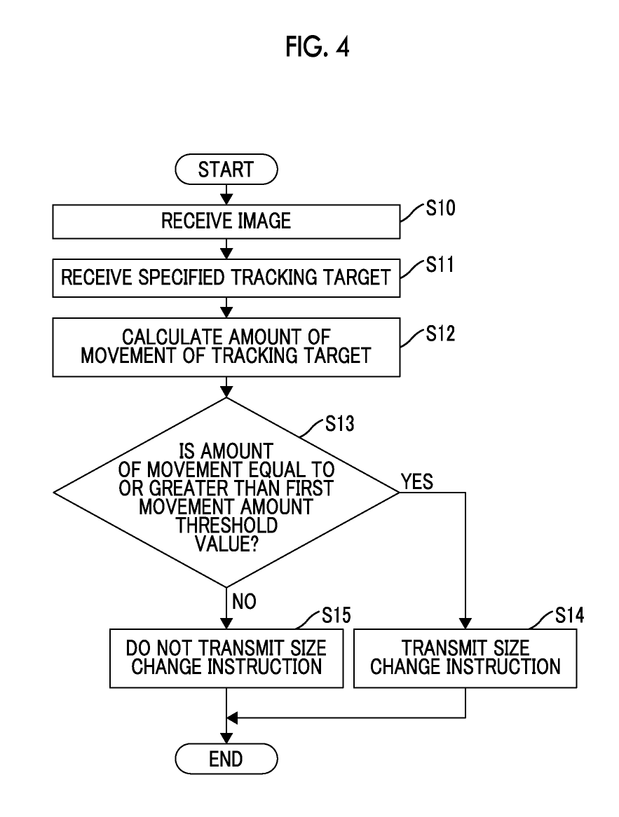

FIG. 4 is a flowchart illustrating the operation of the operation device 100 according to a first embodiment.

First, the operation device 100 receives the images which are continuously transmitted from the camera-side communication unit 50 of the camera 10, using the terminal-side communication unit 110 (Step S10). Then, the tracking target receiving unit receives a specified tracking target (Step S11). Then, the movement amount calculation unit 191 calculates the amount of movement of the tracking target in the continuously received images (Step S12). The movement amount determination unit 193 determines whether the calculated amount of movement is equal to or greater than the first movement amount threshold value (Step S13).

In a case in which the movement amount determination unit 193 determines that the amount of movement is equal to or greater than the first threshold value, the size instruction transmission unit 195 transmits an instruction to change the size of the image from the first size to the second size smaller than the first size to the camera 10 (Step S14). In a case in which the movement amount determination unit 193 determines that the amount of movement is less than the first threshold value, the size instruction transmission unit 195 does not transmit the instruction (Step S15).

As described above, in this embodiment, in a case in which the amount of movement of the tracking target is equal to or greater than the first movement amount threshold value, an instruction to change the size of the image transmitted from the camera 10 to a small size is transmitted. Therefore, a reduction in the frame rate received by the operation device 100 is prevented and it is possible to continue to track a tracking target with high accuracy even when the amount of movement of the tracking target is large. In addition, in this embodiment, in a case in which the amount of movement of the tracking target is less than the first movement amount threshold value, the instruction to change the size of the image transmitted from the camera 10 to a small size is not transmitted. Therefore, the size of the image is not reduced and it is possible to continue to track a tracking target with high accuracy even when the tracking target is small.

The above-mentioned structures and functions can be appropriately implemented by arbitrary hardware, arbitrary software, or a combination thereof. For example, the invention can also be applied to a program that causes a computer to perform each of the above-mentioned processing steps (procedures), a computer-readable recording medium (non-transitory medium) that stores the program, or a computer in which the program can be installed.

### Second Embodiment

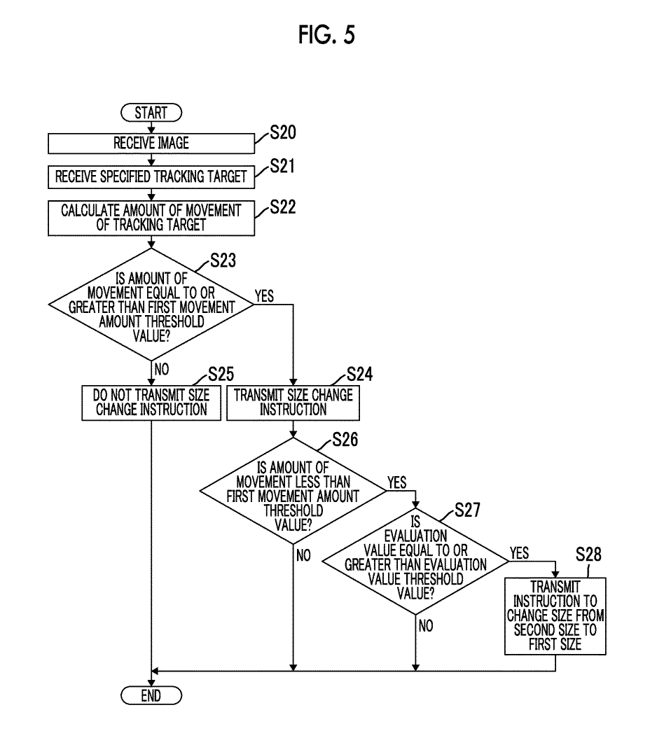

Next, as a second embodiment, a case in which the size instruction transmission unit 195 transmits an instruction to change the size of an image from the second size to the first size will be described. FIG. 5 is a flowchart illustrating the operation of an operation device 100 according to a second embodiment.

First, the terminal-side communication unit 110 receives the images which are continuously transmitted from the camera-side communication unit 50 (Step S20). Then, the tracking target receiving unit receives a specified tracking target (Step S21). Then, the movement amount calculation unit 191 calculates the amount of movement of the tracking target in the continuously received images (Step S22). The movement amount determination unit 193 determines whether the calculated amount of movement is equal to or greater than the first movement amount threshold value (Step S23).

In a case in which the movement amount determination unit 193 determines that the amount of movement is equal to or greater than the first threshold value, the size instruction transmission unit 195 transmits an instruction to change the size of the image from the first size to the second size smaller than the first size to the camera 10 (Step S24). In a case in which the movement amount determination unit 193 determines that the amount of movement is less than the first threshold value, the size instruction transmission unit 195 does not transmit the instruction (Step S25).

After the size instruction transmission unit 195 transmits the instruction to reduce the size from the first size to the second size, the movement amount calculation unit 191 calculates the amount of movement of the tracking target. Then, the movement amount determination unit 193 determines the calculated amount of movement (Step S26). The evaluation value determination unit 201 determines whether the evaluation value of tracking performed by the tracking processing unit 197 is equal to or greater than an evaluation value threshold value (Step S27). Then, in a case in which the evaluation value is determined to be equal to or greater than the evaluation value threshold value, the size instruction transmission unit 195 transmits an instruction to change the size from the second size to the first size larger than the second size (Step S28).

As described above, in this embodiment, in a case in which the amount of movement of an object is determined to be less than a second movement amount threshold value and the evaluation value of tracking is determined to be equal to or greater than the evaluation value threshold value, an instruction to change the size of the image to the original large size is transmitted. Therefore, in this embodiment, the operation device 100 can perform a tracking processing using an image with a large size. As a result, it is possible to perform tracking with high accuracy.

### Third Embodiment

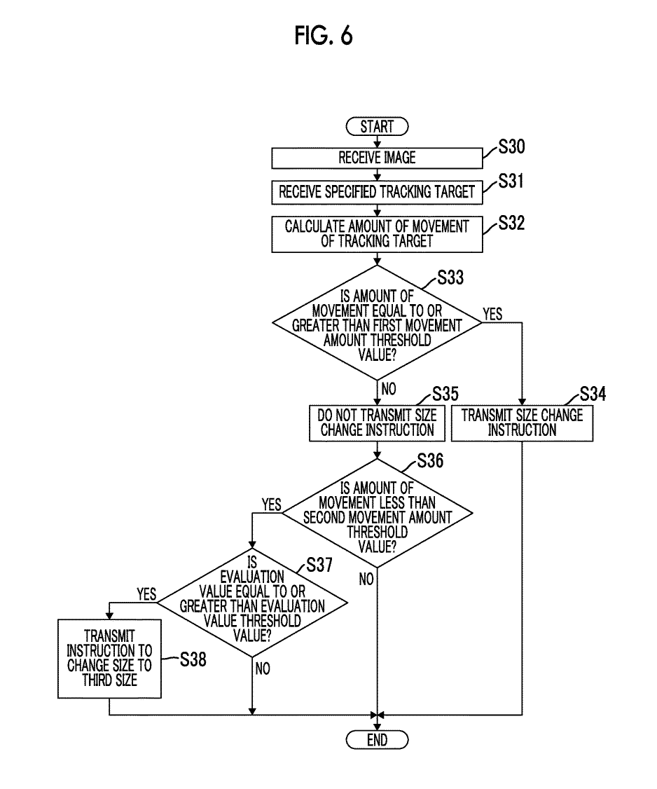

Next, as a third embodiment, a case in which the size instruction transmission unit 195 transmits an instruction to change the size of an image from the first size to a third size will be described. FIG. 6 is a flowchart illustrating the operation of an operation device 100 according to the third embodiment.

First, the terminal-side communication unit 110 receives the images which are continuously transmitted from the camera-side communication unit 50 (Step S30). Then, the tracking target receiving unit receives a specified tracking target (Step S31). Then, the movement amount calculation unit 191 calculates the amount of movement of the tracking target in the continuously received images (Step S32). The movement amount determination unit 193 determines whether the calculated amount of movement is equal to or greater than the first movement amount threshold value (Step S33).

In a case in which the movement amount determination unit 193 determines that the amount of movement is equal to or greater than the first threshold value, the size instruction transmission unit 195 transmits an instruction to change the size of the image from the first size to the second size smaller than the first size to the camera 10 (Step S34). In a case in which the movement amount determination unit 193 determines that the amount of movement is less than the first threshold value, the size instruction transmission unit 195 does not transmit the instruction (Step S35).

After the size instruction transmission unit 195 does not transmit the instruction to change the size of the image, the movement amount determination unit 193 determines whether the amount of movement of the tracking target is less than a second movement amount threshold value (Step S36). Then, in a case in which the amount of movement of the tracking target is less than the second movement amount threshold value, the evaluation value determination unit 201 determines whether the evaluation value is equal to or greater than the evaluation value threshold value (Step S37). Then, in a case in which the evaluation value is equal to or greater than the evaluation value threshold value, an instruction to change the size of the image from the first size to the third size larger than the first size is transmitted (Step S38).

As described above, in this embodiment, in a case in which the amount of movement of an object is determined to be less than the second movement amount threshold value and the evaluation value of tracking is determined to be equal to or greater than the evaluation value threshold value, an instruction to change the size of the image to a large size is transmitted. Therefore, in this embodiment, the operation device 100 can perform a tracking processing using an image with a large size. As a result, it is possible to perform tracking with high accuracy.

### Fourth Embodiment

Next, a fourth embodiment will be described.

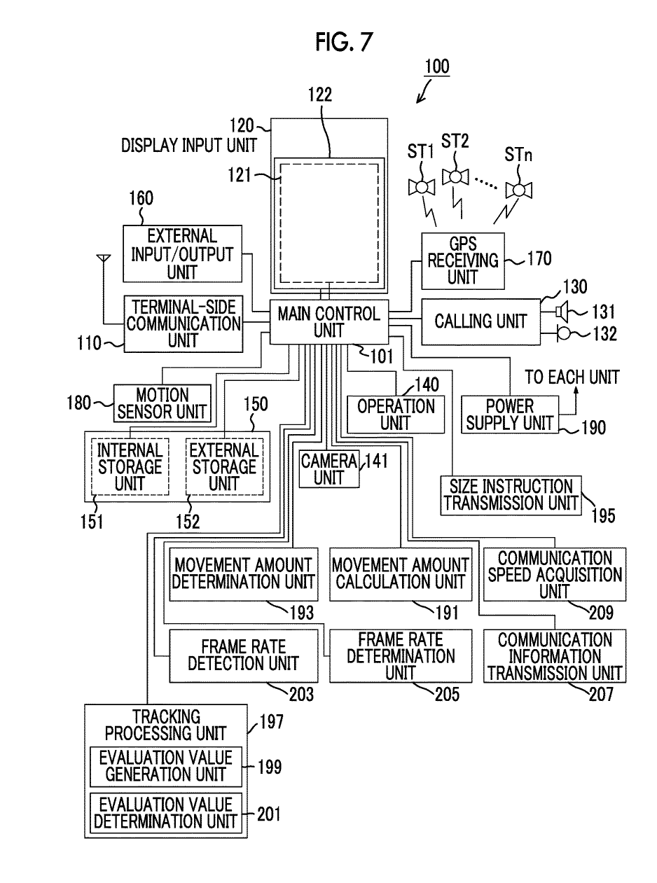

FIG. 7 is a block diagram illustrating an example of the functional structure of an operation device 100 according to the fourth embodiment. The same functional blocks as those described in FIG. 3 are denoted by the same reference numerals and the description thereof will not be repeated.

The operation device 100 according to the fourth embodiment differs from the operation device 100 illustrated in FIG. 3 in that it further includes a frame rate detection unit 203, a frame rate determination unit 205, a communication information transmission unit 207, and a communication speed acquisition unit 209.

The frame rate detection unit 203 detects the frame rate of the images which are continuously received by the receiving unit. That is, the frame rate detection unit 203 detects the frame rate of the images which have been continuously transmitted from the camera-side communication unit 50 of the camera 10 and then received by the terminal-side communication unit 110.

The frame rate determination unit 205 determines whether the frame rate detected by the frame rate detection unit 203 is less than a frame rate threshold value. In a case in which the frame rate is less than the frame rate threshold value, the communication between the camera-side communication unit 50 of the camera 10 and the terminal-side communication unit 110 of the operation device 100 is poor. In a case in which the frame rate is equal to or greater than the frame rate threshold value, the communication between the camera-side communication unit 50 of the camera 10 and the terminal-side communication unit 110 of the operation device 100 is good. The frame rate threshold value may be set according to the size of the image transmitted by the camera 10. In this case, since the frame rate threshold value is set according to the size of the image, it is possible to determine the frame rate with high accuracy.

The communication information transmission unit 207 transmits information about the state of communication with the camera 10 to the camera 10. That is, in a case in which the frame rate determination unit 205 determines that the frame rate is less than the frame rate threshold value, the communication information transmission unit 207 transmits information about a communication error as the information about the communication state. According to this structure, in a case in which the frame rate is less than the frame rate threshold value, the information about the communication error is transmitted to the camera 10. Therefore, the camera 10 can check the communication state of the operation device 100.

The communication speed acquisition unit 209 acquires a communication speed with the camera 10 on the basis of the frame rate detected by the frame rate detection unit 203. Specifically, the communication speed acquisition unit 209 acquires the communication speed between the camera 10 and the operation device 100 on the basis of the value of the frame rate detected by the frame rate detection unit 203. For example, the communication speed acquisition unit 209 has table data in which the frame rate and the communication speed are associated with each other and acquires the communication speed on the basis of the table data.

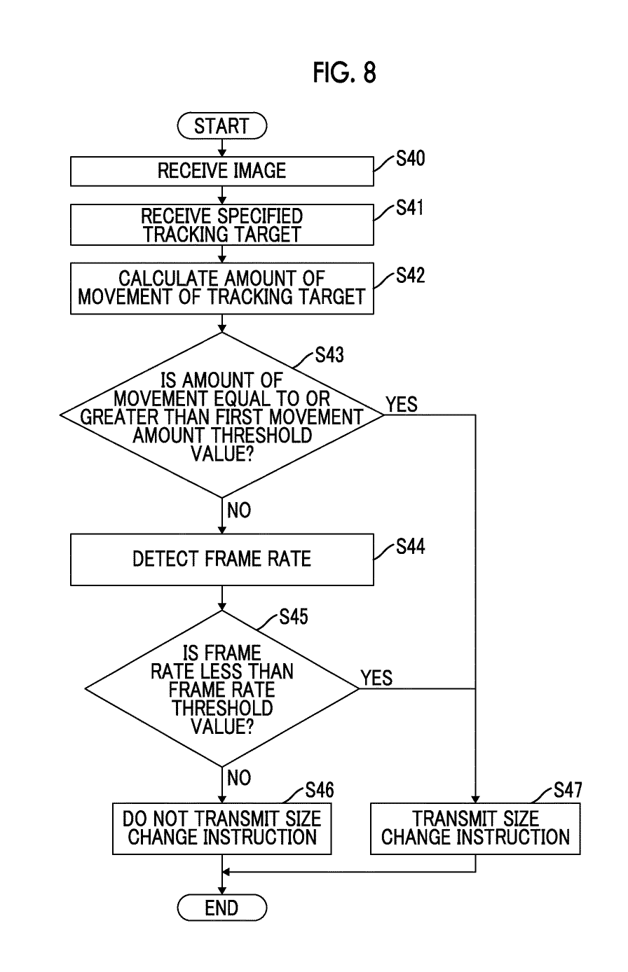

FIG. 8 is a flowchart illustrating the operation of the operation device 100 according to the fourth embodiment.

First, the terminal-side communication unit 110 receives the images that are continuously transmitted from the camera-side communication unit 50 (Step S40). The tracking target receiving unit receives a specified tracking target (Step S41). The movement amount calculation unit 191 calculates the amount of movement of the tracking target in the continuously received images (Step S42). The movement amount determination unit 193 determines whether the calculated amount of movement is equal to or greater than the first movement amount threshold value (Step S43).

Then, in a case in which the amount of movement is determined to be equal to or greater than the first threshold value, the operation device 100 transmits an instruction to change the size of the image from the first size to the second size smaller than the first size to the camera 10 (Step S47). In a case in which the movement amount determination unit 193 determines that the amount of movement is less than the first threshold value, the frame rate detection unit 203 detects the frame rate which is received by the operation device 100 through the terminal-side communication unit 110 (Step S44). Then, the frame rate determination unit 205 determines whether the detected frame rate is less than the frame rate threshold value (Step S45). In a case in which the detected frame rate is less than the frame rate threshold value, the size instruction transmission unit 195 transmits an instruction to change the size of the image from the first size to the second size. On the other hand, in a case in which the detected frame rate is equal to or greater than the frame rate threshold value, the size instruction transmission unit 195 does not transmit the instruction to change the size (Step S46).

As described above, in this embodiment, in a case in which the frame rate is less than the frame rate threshold value, the instruction to change the size of the image to the second size is transmitted. Therefore, it is possible to increase a low frame rate. According to this aspect, even when the amount of movement of a tracking target is large, it is possible to track the tracking target with high accuracy.

The embodiments of the invention have been described above. However, the invention is not limited to the above-described embodiments and various modifications and changes of the invention can be made without departing from the scope and spirit of the invention.

### EXPLANATION OF REFERENCES

10: camera
12: device body
14: base
16: holding portion
16A: gear
18: dome cover
19: imaging start button
20: imaging unit
22: imaging lens
23: stop
24: imaging element
26: lens driving unit
28: CMOS driver
30: imaging direction adjustment unit
32: pan/tilt mechanism
34: pan driving unit
36: tilt driving unit
40: control unit
41: signal processing unit
42: imaging control unit
43: lens control unit
44: direction control unit
46: operation control unit
50: camera-side communication unit
60: operation unit
61: camera-side display unit
62: memory
65: size change unit
100: operation device
101: main control unit
102: housing
110: terminal-side communication unit
120: display input unit
121: display panel
122: operation panel
130: calling unit
131: speaker
132: microphone
140: operation unit
141: camera unit
150: storage unit
151: internal storage unit
152: external storage unit
160: external input/output unit
170: GPS receiving unit
180: motion sensor unit
190: power supply unit
191: movement amount calculation unit
193: movement amount determination unit
195: size instruction transmission unit
197: tracking processing unit
199: evaluation value generation unit
201: evaluation value determination unit
300: tracking system

What is claimed is:

1. An operation device that transmits control information for an automatic tracking function to a camera with the automatic tracking function, comprising:
a receiving unit that receives images which are continuously transmitted from the camera;
a tracking target receiving unit that receives a specified tracking target which is tracked by the camera;
a movement amount calculation unit that calculates an amount of movement of the tracking target in the images continuously received by the receiving unit on the basis of the continuous images;
a movement amount determination unit that determines whether the amount of movement calculated by the movement amount calculation unit is equal to or greater than a first movement amount threshold value; and
a size instruction transmission unit that transmits an instruction to change a size of the image transmitted by the camera from a first size to a second size smaller than the first size to the camera in a case in which the movement amount determination unit determines that the amount of movement is equal to or greater than the first movement amount threshold value.

2. The operation device according to claim 1, further comprising:
a tracking processing unit that performs image processing for the image to track the tracking target,
wherein the tracking processing unit includes:
an evaluation value generation unit that generates an evaluation value indicating accuracy of the tracking; and
an evaluation value determination unit that determines whether the evaluation value generated by the evaluation value generation unit is equal to or greater than an evaluation value threshold value, and
in a case in which the movement amount determination unit determines that the amount of movement is less than the first movement amount threshold value and the evaluation value determination unit determines that the evaluation value is equal to or greater than the evaluation value threshold value after the size instruction transmission unit transmits the instruction to change the size of the image to the second size, the size instruction transmission unit transmits an instruction to change the size of the image from the second size to the first size.

3. The operation device according to claim 1, further comprising:
a tracking processing unit that performs image processing to track the tracking target,
wherein the tracking processing unit includes:
an evaluation value generation unit that generates an evaluation value indicating accuracy of the tracking; and
an evaluation value determination unit that determines whether the evaluation value generated by the evaluation value generation unit is equal to or greater than an evaluation value threshold value,
the movement amount determination unit determines whether the amount of movement is less than a second movement amount threshold value less than the first movement amount threshold value, and
in a case in which the movement amount determination unit determines that the amount of movement is less than the second movement amount threshold value and the evaluation value determination unit determines that the evaluation value is equal to or greater than the evaluation value threshold value, the size instruction transmission unit generates an instruction to change the size of the image to a third size larger than the first size.

4. The operation device according to claim 2,
wherein the evaluation value generation unit generates the evaluation value on the basis of a sum of absolute values of differences between pixels of a template image and pixels of the image of a region corresponding to the template image in block matching.

5. The operation device according to claim 1, further comprising:
a frame rate detection unit that detects a frame rate of the image continuously received by the receiving unit; and
a frame rate determination unit that determines whether the frame rate detected by the frame rate detection unit is less than a frame rate threshold value,
wherein, in a case in which the frame rate determination unit determines that the frame rate is less than the frame rate threshold value, the size instruction transmission unit transmits the instruction to change the size of the image to the second size.

6. The operation device according to claim 5, further comprising:
a communication speed acquisition unit that acquires a communication speed with the camera on the basis of the frame rate detected by the frame rate detection unit.

7. The operation device according to claim 5, further comprising:
a communication information transmission unit that transmits information about a state of communication with the camera to the camera,
wherein, in a case in which the frame rate determination unit determines that the frame rate is less than the frame rate threshold value, the communication information transmission unit transmits information about a communication error as the information about the communication state.

8. The operation device according to claim 5,
wherein the frame rate threshold value is set according to the size of the image transmitted by the camera.

9. The operation device according to claim 1, further comprising:
a display unit that displays the image continuously transmitted from the camera; and
an input unit that designates an input position on a screen of the display unit,
wherein the tracking target receiving unit receives an object at the input position designated by the input unit as the tracking target.

10. A tracking system comprising:
a camera; and
an operation device that is used to operate the camera,
wherein the camera comprises:
an imaging unit that acquires an image;
an imaging direction switching mechanism that switches an imaging direction of the imaging unit;
an image transmission unit that transmits the image;
an instruction receiving unit that receives an instruction from the operation device; and
a size change unit that changes a size of the image transmitted from the image transmission unit to the operation device on the basis of an instruction from the operation device which transmits an instruction to change the size of image according to a reception state of the image transmitted by the image transmission unit, and
the operation device comprises:
a receiving unit that receives the images which are continuously transmitted from the camera;
a tracking target receiving unit that receives a specified tracking target which is tracked by the camera;
a movement amount calculation unit that calculates an amount of movement of the tracking target in the images continuously received by the receiving unit on the basis of the continuous images;
a movement amount determination unit that determines whether the amount of movement calculated by the movement amount calculation unit is equal to or greater than a first movement amount threshold value; and
a size instruction transmission unit that transmits an instruction to change the size of the image transmitted by the camera from a first size to a second size smaller than the first size to the camera in a case in which the movement amount determination unit determines that the amount of movement is equal to or greater than the first movement amount threshold value.

11. An operation method that transmits control information for an automatic tracking function to a camera with the automatic tracking function, the method comprising:
a receiving step of receiving images which are continuously transmitted from the camera;
a tracking target receiving step of receiving a specified tracking target which is tracked by the camera;
a movement amount calculation step of calculating an amount of movement of the tracking target in the images continuously received in the receiving step on the basis of the continuous images;
a movement amount determination step of determining whether the amount of movement calculated in the movement amount calculation step is equal to or greater than a first movement amount threshold value; and
a size instruction transmission step of transmitting an instruction to change a size of the image transmitted by the camera from a first size to a second size smaller than the first size to the camera in a case in which it is determined in the movement amount determination step that the amount of movement is equal to or greater than the first movement amount threshold value.

12. The operation method according to claim 11, further comprising:
a tracking processing step of performing image processing for the image to track the tracking target,
wherein the tracking processing step includes:
an evaluation value generation step of generating an evaluation value indicating accuracy of the tracking; and
an evaluation value determination step of determining whether the evaluation value generated in the evaluation value generation step is equal to or greater than an evaluation value threshold value, and
in a case in which it is determined in the movement amount determination step that the amount of movement is less than the first movement amount threshold value and it is determined in the evaluation value determination step that the evaluation value is equal to or greater than the evaluation value threshold value after the instruction to change the size of the image to the second size is transmitted, an instruction to change the size of the image from the second size to the first size is transmitted in the size instruction transmission step.

13. The operation method according to claim 11, further comprising:
a tracking processing step of performing image processing to track the tracking target,
wherein the tracking processing step includes:
an evaluation value generation step of generating an evaluation value indicating accuracy of the tracking; and
an evaluation value determination step of determining whether the evaluation value generated in the evaluation value generation step is equal to or greater than an evaluation value threshold value,
in the movement amount determination step, it is determined whether the amount of movement is less than a second movement amount threshold value less than the first movement amount threshold value, and
in a case in which it is determined in the movement amount determination step that the amount of movement is less than the second movement amount threshold value and it is determined in the evaluation value determination step that the evaluation value is equal to or greater than the evaluation value threshold value, an instruction to change the size of the image to a third size larger than the first size is generated in the size instruction transmission step.

14. The operation method according to claim 12,
wherein, in the evaluation value generation step, the evaluation value is generated on the basis of a sum of absolute values of differences between pixels of a template image and pixels of the image of a region corresponding to the template image in block matching.

15. The operation method according to claim 11, further comprising:
a frame rate detection step of detecting a frame rate of the image continuously received in the receiving step; and
a frame rate determination step of determining whether the frame rate detected in the frame rate detection step is less than a frame rate threshold value,
wherein, in a case in which it is determined in the frame rate determination step that the frame rate is less than the frame rate threshold value, the instruction to change the size of the image to the second size is transmitted in the size instruction transmission step.

16. The operation method according to claim 15, further comprising:
a communication speed acquisition step of acquiring a communication speed with the camera on the basis of the frame rate detected in the frame rate detection step.

17. The operation method according to claim 15, further comprising:
a communication information transmission step of transmitting information about a state of communication with the camera to the camera,
wherein, in a case in which it is determined in the frame rate determination step that the frame rate is less than the frame rate threshold value, information about a communication error is transmitted as the information about the communication state in the communication information transmission step.

18. The operation method according to claim 15,
wherein the frame rate threshold value is set according to the size of the image transmitted by the camera.

19. The operation method according to claim 11, further comprising:
a display step of displaying the image continuously transmitted from the camera; and
an input step of designating an input position on a screen in the display step,
wherein, in the tracking target receiving step, an object at the input position designated in the input step is received as the tracking target.

20. A non-transitory computer-readable tangible medium having a program that causes a computer to perform the operation method according to claim 11.
